(19) United States
(12) Patent Application Publication
(10) Pub. No.: US 2014/0167514 A1
(43) Pub. Date: Jun. 19, 2014

(54) Method and Apparatus for Powering a Battery-Operable Device with an External Source of Power

(71) Applicant: Raz Imports, Inc., Arlington, TX (US)

(72) Inventors: Kenneth Carl Row, Arlington, TX (US); Stone Lai, Guang Dong (CN)

(73) Assignee: RAZ IMPORTS, INC., Arlington, TX (US)

(21) Appl. No.: 14/106,741

(22) Filed: Dec. 14, 2013

Related U.S. Application Data
(60) Provisional application No. 61/737,673, filed on Dec. 14, 2012.

(51) Int. Cl. H02J 9/00

(52) U.S. Cl. CPC H02J 9/00
USPC 307/66

(57) ABSTRACT

Object having terminals for supplying power to a battery-operable device when the object is inserted into a battery holder, and a transmission line is coupled to the object for supplying power from an external source of power to the terminals of the object. For example, the transmission line is thin and flat so a battery compartment cover can be fully closed over the transmission line, and the transmission line is also coupled to an external electrical connector to receive power from the external source through the external connector. The apparatus can include multiple objects. The transmission line can provide power from the external source to the terminals of only one of the objects, and the other objects can have their terminals shorted together. The multiple objects can be strung together so that they do not become lost or misplaced.

### CROSS-REFERENCE TO RELATED APPLICATIONS

The present application claims priority and the benefit of U.S. Provisional Patent Application No. 61/737,673, filed Dec. 14, 2012, which is hereby incorporated by reference in its entirety.

### FIELD

The present disclosure relates to a method and apparatus for powering a battery-operable device with an external source of power.

### BACKGROUND

Many battery-operable devices have a jack for powering the device with an external source of power. Such battery-operable devices include clocks, radios, media players, and computers. The external source of power typically is an AC/DC adaptor that plugs into a standard 120 volt electrical wall socket.

### BRIEF DESCRIPTION OF THE DRAWINGS

FIG. 1 is a perspective view showing an apparatus for powering a battery-operable device with an external source of power.

FIG. 2 is a top view of the apparatus in FIG. 1 that is used to couple the battery-operable device of FIG. 1 to the AC/DC adapter in FIG. 1.

FIG. 3 is a cross-sectional view of a thin flat electrical transmission line along section line 3-3 in FIG. 2;

FIG. 4 is a schematic diagram showing electrical and mechanical connections in the apparatus of FIG. 2;

FIG. 5 is a schematic diagram showing a first alternative to the apparatus of FIG. 4 in which a pair of silicon rectifier diodes reduce the voltage from the external source of power;

FIG. 6 is a schematic diagram showing a second alternative to the apparatus of FIG. 4 in which a backup rechargeable battery provides a reliable backup source of power to the battery-operable device;

FIG. 7 is a schematic diagram showing a third alternative to the apparatus of FIG. 4 for powering a battery-operable device with three battery cells;

FIG. 8 shows a fourth alternative that includes an additional junction enclosure;

FIG. 9 shows a fifth alternative that includes the additional junction enclosure and three battery cells; and

FIG. 10 shows a sixth alternative apparatus for powering a battery-operable device with an external source of power when the battery-operable device is configured to receive a button-type battery.

While the present disclosure is susceptible to various modifications and alternative forms, specific embodiments thereof have been shown in the drawings and will be described in detail. It should be understood, however, that it is not intended to limit the present disclosure to the particular forms shown, but on the contrary, the intention is to cover all modifications, equivalents, and alternatives falling within the scope of the present disclosure as defined by the appended claims.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “coupled” is defined as connected, whether directly or indirectly through intervening components, and is not necessarily limited to physical connections. The connection can be such that the objects are permanently connected or releasably connected.

A method and apparatus for powering a battery-operable device with an external source of power is presented herein. The method and apparatus can be used when the battery-operable device does not have a jack for connecting the device to an external source of power. The method and apparatus can also be used to provide a more reliable source of power when the battery-operable device has a jack for connecting the device to an external source of power.

In accordance with one aspect, the present disclosure can provide an apparatus for powering a battery-operable device with an external source of power. The apparatus can include at least one object, which can be battery shaped, having terminals for supplying power to the battery-operable device when said at least one battery-shaped object is inserted into a battery holder of the battery-operable device. The apparatus can further include a transmission line extending from said at least one battery-shaped object for supplying power from the external source of power to the terminals of said at least one battery-shaped object. While the present disclosure is described in relation to battery shaped objects, the present disclosure can be implemented with other objects that allow for substantial or at least partial conformance with a battery shaped receiver. While the remaining description uses the term batter shaped object, another shape can be used without departure from the disclosure. When a battery shaped object is used, the battery shaped object can be held in place better by a battery compartment and related components.

In accordance with another aspect, the present disclosure can provide a method of powering a battery-operable device with an external source of power. The method can include the steps of: (a) inserting at least one battery-shaped object in a battery holder of the batter-operable device; and/or (b) supplying power from the external source of power through a transmission line to terminals of said at least one battery-shaped object so that power is supplied from the terminals to the battery-operable device to operate the battery-operable device.

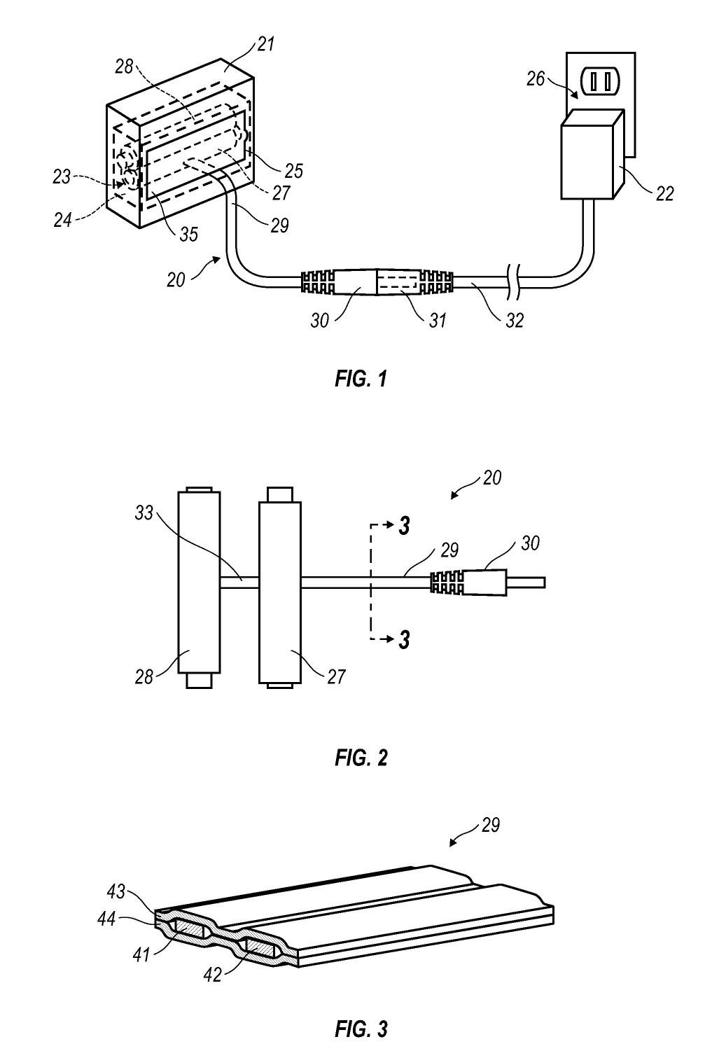

With reference to FIG. 1, there is shown an apparatus 20 for powering a battery-operable device 21 with an external source of power 22. The battery-operable device 21, for example, is a clock radio. While a clock radio is illustrated, the present disclosure contemplates implementation of the present technology with other battery operable devices such as Christmas ornaments, decorations, and clocks. The battery-operable device 21 can have an internal battery compartment 23 for receiving two “AA” size battery cells in a battery holder 24, and a battery compartment cover 25. The external source of power 22 can be an AC/DC adapter plugged into a standard 120 VAC wall socket 26.

In order to power the battery-operable device 21 with the external source of power 22, the apparatus 20 can include two battery-shaped objects 27, 28 for providing electrical connections within the battery compartment 23 to the battery-operable device. Each of the battery-shaped objects 27, 28 can have the external size and shape of one “AA” size battery cell. In other embodiments, the external size and shape of the battery-shaped objects is dependent upon the battery compartment of the battery-operable device 21 into which the battery-shaped objects 27, 28 are to be inserted.

The apparatus 20 further can include a transmission line 29 for supplying power from the external source of power 22 to at least one of the battery-shaped objects 27, 28 so that at least one of the battery-shaped objects can provide power to the battery-operable device 21. The transmission line 20 is terminated externally by an electrical connector 30 that mates with an electrical connector 31 on an electrical cable 32 from the external source of power 22. While an electric connectors 30, 31 are illustrated, the present technology can be implemented without a connector. In at least one embodiment, the electric connectors 30, 31 can be configured to insure that a properly sized battery-shaped object is connected thereto.

So that the battery compartment cover 24 can fully close when the apparatus 20 is used to power the battery-operable device 21, the transmission line 29 is a thin, flat ribbon. Therefore the transmission line 29 can pass through a crack 35 between the battery compartment 23 and the battery compartment cover 25. Full closure of the battery compartment cover 25 prevents the cover from becoming broken or lost or misplaced due to detachment from the battery-operable device 21.

FIG. 2 is a top view of the apparatus 20. To prevent the battery-shaped object 28 from becoming lost or misplaced, a thin braided-fiber ribbon 33 can string the two battery-shaped objects 27, 28 together. The braided-fiber ribbon 38 can thin so that it is stuffed easily into the battery compartment (23 in FIG. 1) without preventing full closure of the battery compartment cover 25. While a braided-fiber ribbon is described herein, other coupling components can be used in place of the braided-fiber ribbon without departing from the present disclosure. Other coupling devices include monofilament, wire, elastic, rubber, or other flexible material. The term braided-fiber ribbon is used herein, but others can be substituted as necessary.

FIG. 3 shows an example of a cross-sectional view of the transmission line 29. The transmission line 29 can include two parallel-spaced strips 41, 42 of copper foil sandwiched between two strips of plastic 43, 44. The copper foil 41, 42 and the plastic strips 43, 44 can be of the kind commonly used in flexible printed circuits. For example, the transmission line 29 is one of many made from a sheet of flexible printed circuit material by lithographic etching of the copper foil, and then laminating another plastic sheet onto the etched printed circuit sheet, and then slicing up the laminated sheet assembly into transmission line ribbons.

For example, the copper foil can 0.07 mm thick, the plastic sheet is 0.05 mm thick and made of polyethylene terephthalate (PET), and the plastic layers are bonded together with thermoset adhesive. In this case, the thickness of the transmission line 29 can be about 0.2 mm. It is practical for the thickness of the transmission line to be within the range of 0.05 mm to 0.3 mm. Other configurations can be within the scope of the present disclosure provided that the resulting transmission line 29 allows for substantial compliance with an existing battery compartment.

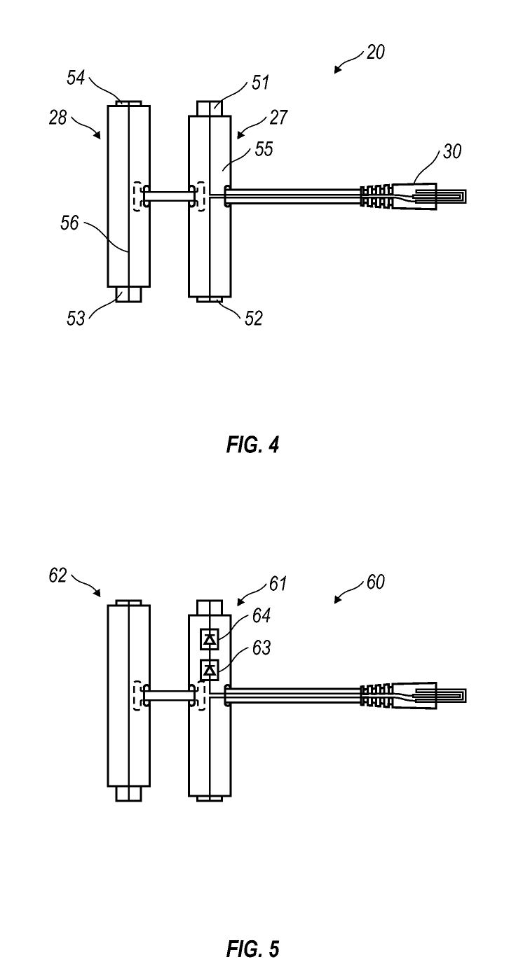

FIG. 4 further shows electrical and mechanical connections in the apparatus 20. The first transmission line conductor 41 is electrically connected to a positive terminal 51 of the first battery-shaped object 27, and the second transmission line conductor 42 is electrically connected to a negative terminal 52 of the first battery-shaped object. The two transmission line conductors 41, 42 are also wired to the electrical connector 30 so that the DC voltage of the AC/DC adapter (22 in FIG. 1) appears across the terminals 51 and 52 so that this DC voltage appears positive at the terminal 51 and negative at the terminal 52. In the illustrated embodiments, the connections can be internal to the apparatus such that they are not visible from the outside. The illustrations herein are used to provide details regarding the electrical connections. Additionally, not all of the connections are shown. For example, there can be a coupling component for each of the terminals 51 and 52 that are not illustrated. In other embodiments, the coupling components can be omitted and the wire soldered or otherwise bonded to the terminals 51 and 52. In at least one embodiment, the internal wire can be insulted and/or shielded. In other embodiments, the battery-shaped object can provide the insulating and/or shielding.

For example, the positive terminal 51 is a metal disk, and the negative terminal 52 also is a metal disk. The positive and negative terminals 51, 52 are attached to opposite ends of a plastic tube 55 forming the body of the first battery-shaped object 27. The second battery-shaped object 28 has a similar construction.

In the example of FIG. 4, the second battery-shaped object 28 has a positive terminal 53 shorted internally by a wire 56 to the negative terminal 54. Therefore the battery-shaped object 28 is a “dummy” battery providing zero volts. The AC/DC adapter (22 in FIG. 1) supplies three volts DC to the first battery-shaped object 27 so that the pair of battery-shaped objects 27, 28 function as a pair of good batteries when installed in the battery holder (24 in FIG. 1) of the battery-operable device (21 in FIG. 1).

FIG. 5 shows a second apparatus 60 having a first battery-shaped object 61 and a second battery-shaped object 62. The apparatus 60 is similar to the apparatus 20 in FIG. 2 except that the apparatus 60 includes two silicon rectifier diodes (such as part No. 1N4001) in series to provide a voltage drop of about 1.5 volts. Therefore the AC/DC adapter (22 in FIG. 1) should supply 4.5 volts DC to the first battery-shaped object 27 so that the pair of battery-shaped objects 28, 27 functions as a pair of good batteries when installed in the battery holder (24 in FIG. 1) of the battery-operable device (21 in FIG. 1). This permits a single 4.5 volt AD/DC adapter to power either the apparatus 60 FIG. 5 or a similar apparatus (described further below with reference to FIG. 7) that has three battery-shaped objects. While two silicon rectifier diodes are illustrated, a single silicon rectifier diode or other type of diode can be implemented. When implemented with one or more diodes, the apparatus can be configured to supply a desired voltage given a known voltage power source.

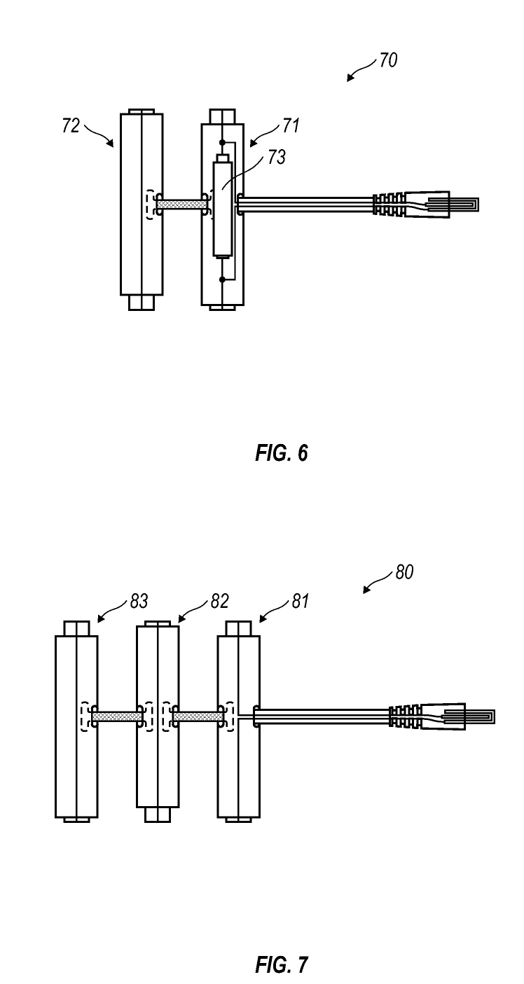

FIG. 6 shows a third apparatus 70 having a first battery-shaped object 71 and a second battery-shaped object 72. The apparatus 70 is similar to the apparatus 20 in FIG. 4 except that the apparatus 70 includes a backup rechargeable battery 73. In this third apparatus 70 the backup rechargeable battery 73 provides power to the battery-operable device when there is a temporary failure of the external source of power. In this way, the apparatus 70 can power a battery-operable device such as an alarm clock or thermostat that should have a very reliable source of power in order to maintain time or temperature settings. The rechargeable battery 73, for example, is a lithium iron phosphate (LiFePO₄) battery.

FIG. 7 shows a fourth apparatus 80 having a first battery-shaped object 81, a second battery-shaped object 82, and a third battery-shaped object 83. The apparatus 80 is similar to the apparatus 30 of FIG. 4 except that the apparatus 80 includes a third “dummy” battery 83. Therefore the three battery-shaped objects 81, 82, 83 will function as “good” batteries (in a battery-operable device using three “AA” batteries to provide 4.5 volts) when connected to an AC/DC adapter supplying 4.5 volts.

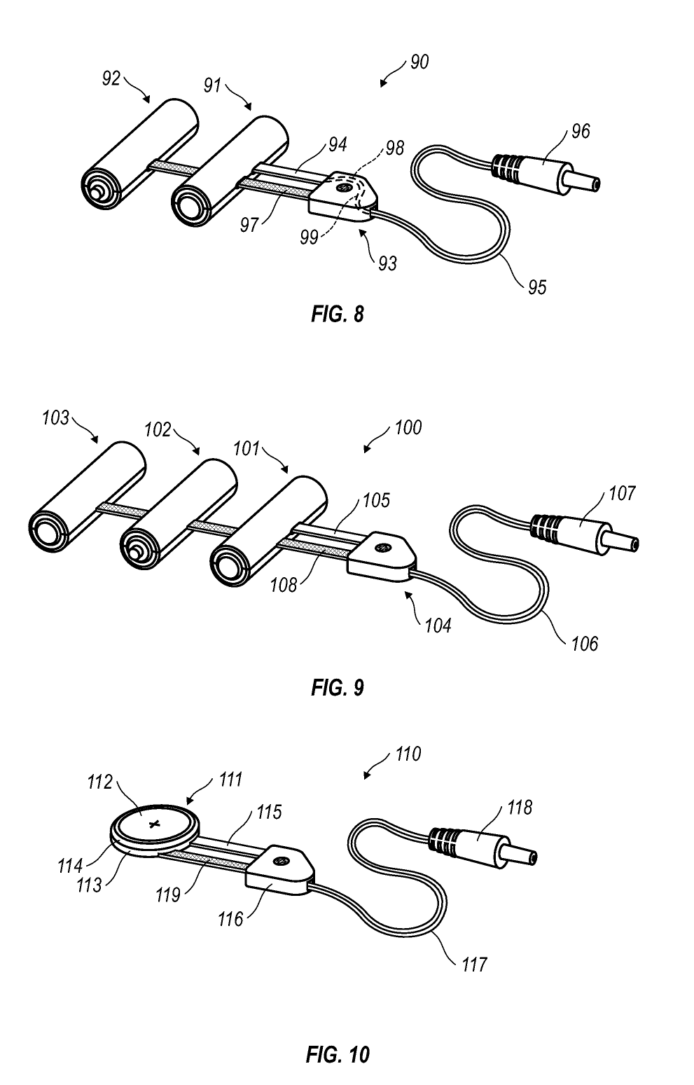

FIG. 8 shows a fifth apparatus 90 having a first battery-shaped object 91 and a second battery-shaped object 92. The apparatus 90 is similar to the apparatus 20 in FIG. 4, 60 in FIG. 5, or 70 in FIG. 6 except that the apparatus 90 in FIG. 8 includes an additional enclosure 93 over electrical connections 98 and 99 between electrical conductors of thin flat transmission line 94 and electrical conductors of a thicker and rounder cable 95 from an electrical connector 96. This additional enclosure 93 simplifies connection of the thin flat transmission line 94 to the electrical connector 96 because the combination of the thicker and rounder cable 95 and the electrical connector 96 is already mass produced as an integral molded item. Additional electrical components (such as a pair of silicon rectifier diodes or a backup rechargeable battery) can be assembled in the enclosure 93 when making the electrical connections between the thin flat transmission line 94 and the thicker and rounder cable 95.

In the fifth apparatus 90, the braided-fiber ribbon 97 extends from the second battery-shaped object 92 and through the first battery-shaped object 91 and terminates within the enclosure 93. The connection of the braided-fiber ribbon 97 between the first battery-shaped object 91 and the enclosure 93 relieves some stress upon the thin flat transmission line 94.

FIG. 9 shows a sixth apparatus 100 having a first battery-shaped object 101, a second battery-shaped object 102, and a third battery-shaped object. The apparatus 100 is similar to the apparatus 80 of FIG. 7 except that the apparatus 100 includes an additional enclosure 104 over a junction between a thin flat transmission line 105 and a thicker and rounder cable 106 from an electrical connector 107. Moreover, the braided-fiber ribbon 108 extend from the third battery-shaped object 103 and through the second battery-shaped object 102 and through the first battery-shaped object 101 to the enclosure 104 in order to relieve some stress upon the thin flat transmission line 105.

Although FIGS. 1 to 9 show apparatus using “AA” size battery-shaped objects, other sizes of battery-shaped objects can be used, such as larger “C” and “D” sizes, or smaller “AAA”, “AAAA”, or “N” sizes, corresponding to the size of the battery holder in the battery-operable device to be powered from the external source of power. The present disclosure also contemplates the implementation with a custom shaped batter compartment or in place of custom rechargeable batteries.

FIG. 10 shows a sixth apparatus 110 in which a battery-shaped object 111 is in the shape of a button-type battery. The battery-shaped object 111 includes a metal positive terminal disc 112, a metal negative terminal disk 113, and a plastic insulator disk 114 spacing the positive terminal 112 from the negative terminal 113. A thin flat transmission line 115 supplies electrical power to the positive terminal 112 and to the negative terminal 113. An enclosure 116 encloses a junction between the thin flat transmission line 115 and a thicker and rounder cable 117 from an electrical connector 118. Additional electrical components (such as a pair of silicon rectifier diodes or a backup rechargeable battery) can be assembled in the enclosure 116 when making the electrical connections between the thin flat transmission line 115 and the thicker and rounder cable 117. A braided-fiber ribbon 119 extends from the battery-shaped object 111 to the enclosure 116 in order to relieve some stress upon the thin flat transmission line 115.

In view of the above, there has been described a method and apparatus for powering a battery-operable device with an external source of power. The apparatus includes at least one battery-shaped object having terminals for supplying power to the battery-operable device when the battery-shaped object is inserted into a battery holder of the battery-operable device, and a transmission line coupled to the battery-shaped object for supplying power from the external source of power to the terminals of the battery-shaped object. For example, the transmission line is thin and flat so that the transmission line can pass through a crack between a battery compartment and a battery compartment cover of the battery-operable device when the battery compartment cover is fully closed. The transmission line is also coupled to an external electrical connector to receive power from the external source through the external electrical connector. The apparatus can include multiple battery-shaped objects. The transmission line can provide power from the external source to the terminals of only one of the battery-shaped objects, and each of the other battery-shaped objects can have their terminals shorted together. The multiple battery-shaped objects are strung together so that they do not become lost or misplaced.

What is claimed is:

1. Apparatus for powering a battery-operable device with an external source of power, said apparatus comprising:
at least one battery-shaped object having terminals for supplying power to the battery-operable device when said at least one battery-shaped object is inserted into a battery holder of the battery-operable device; and
a transmission line extending from said at least one battery-shaped object for supplying power from the external source of power to the terminals of said at least one battery-shaped object.

2. The apparatus as claimed in claim 1, wherein the transmission line is a thin flat strip.

3. The apparatus as claimed in claim 1, wherein the transmission line is comprised of two parallel-spaced metal foil strips sandwiched between two plastic strips.

4. The apparatus as claimed in claim 1, wherein the transmission line has a thickness in the range of 0.3 mm to 0.05 mm.

5. The apparatus as claimed in claim 1, wherein the transmission line has a thickness of no more than 0.2 mm.

6. The apparatus as claimed in claim 1, further including an electrical connector for receiving power from the external source of power, and wherein the transmission line is coupled to the electrical connector for receiving power from the electrical connector.

7. The apparatus as claimed claim 6, wherein the transmission line is a thin flat strip, and further including a cable connected to the electrical connector, and an enclosure enclosing electrical connections between the cable and the transmission line.

8. The apparatus as claimed in claim 7, further including a braided-fiber ribbon connecting the enclosure to said at least one battery-shaped object.

9. The apparatus as claimed in claim 1, which includes more than one battery-shaped object coupled together.

10. The apparatus as claimed in claim 9, wherein the battery-shaped objects are coupled together by a braided-fiber ribbon.

11. The apparatus as claimed in claim 1, wherein the transmission line is connected to only one of the battery-shaped objects for supplying power from the external source of power to a positive terminal and to a negative terminal of said only one of the battery-shaped objects, and each other of the battery-shaped objects has two terminals and an electrical conductor shorting the two terminals together.

12. The apparatus as claimed in claim 1, further including at least two semiconductor rectifier diodes connected in series for providing a voltage drop between the external source of power and the power supplied from the terminals to the battery-operable device.

13. The apparatus as claimed in claim 1, further including a backup rechargeable battery for supplying power to the battery-operable device during a power failure of the source of external power.

14. A method of powering a battery-operable device with an external source of power, said method comprising the steps of:
inserting at least one battery-shaped object into a battery holder of the battery-operable device; and
supplying power from the external source of power through a transmission line to terminals of said at least one battery-shaped object so that power is supplied from the terminals to the battery-operable device to operate the battery-operable device.

15. The method as claimed in claim 14, wherein the transmission line is thin and flat, the battery holder is in a battery compartment of the battery-operable device, and the method further includes closing a cover of the battery compartment over the transmission line so that the cover is fully closed when power is supplied from the external source of power to the terminals of said at least one battery-shaped object through the transmission line.

16. The method as claimed in claim 14, which further includes making an electrical connection between an electrical connector of an AC/DC adapter and an electrical connector coupled to the transmission line for supplying power from the AC/DC adapter to the terminals of said at least one battery-shaped object.

17. The method as claimed in claim 14, which further includes inserting into the battery holder a battery-shaped object having two terminals and an electrical conductor shorting the two terminals together, and performing the step (b) when the battery-shaped object having the two terminals and the electrical conductor shorting the two terminals together is in the battery holder.

18. The method as claimed in claim 14, wherein the external source of power is an AC/DC adapter, and the method further includes producing a drop in DC voltage from the AC/DC adapter through at least two semiconductor rectifier diodes to supply a voltage from the terminals of said at least one battery-shaped object to the battery-operable device that is less that the DC voltage from the AC/DC adapter by at least the drop in DC voltage through said at least two semiconductor rectifier diodes.

19. The method as claimed in claim 14, wherein the external source of power is an AC/DC adapter, and the method further includes supplying power from a backup rechargeable battery to the terminals of said at least one battery-shaped object to continue operation of the battery-operable device upon a failure of receiving power from the AC/DC adapter.
